(19) United States
(12) Patent Application Publication
(10) Pub. No.: US 2025/0247041 A1
(43) Pub. Date: Jul. 31, 2025

(54) BUILDING-INTEGRATED THERMAL PHOTOVOLTAIC BUILDING CLADDING SYSTEM

(71) Applicant: EXA-IP B.V., GC The Hague (NL)

(72) Inventor: Jan-Jaap VAN OS, GC The Hague (NL)

(73) Assignee: EXA-IP B.V., GC The Hague (NL)

(21) Appl. No.: 18/854,565

(22) PCT Filed: Apr. 6, 2023
(86) PCT No.: PCT/NL2023/050182

§ 371 Date: Oct. 7, 2024

(30) Foreign Application Priority Data
Apr. 8, 2022 (NL) 2031542

(51) Int. Cl. H02S 20/23; F24S 20/00; F24S 20/66; F24S 20/67; H02S 40/42

(52) U.S. Cl. CPC H02S 20/23; F24S 20/66; F24S 20/67; H02S 40/425; F24S 2020/17

(57) ABSTRACT

A building integrated thermal and photovoltaic cladding system includes: an exterior layer including photovoltaic elements, an interior layer including heat exchange modules; a load-bearing structure including one or more spacers configured to maintain the exterior layer in spaced apart relation to the interior layer, and providing an air flow conduit therebetween for receiving air from the exterior, the air flow generally passing over the interior layer by natural circulation.

### FIELD OF THE INVENTION

The present invention relates to a building integrated combined air thermal and photovoltaic energy collection systems for building integration. It furthermore relates to devices comprising solar modules with photovoltaic energy output and thermal energy output, and in particular to roofs or claddings comprising photovoltaic panels and air-fluid heat exchange modules for a heat extraction or induction system.

### BACKGROUND OF THE INVENTION

With a recent focus on the topic of climate change, research and development has, in part, been directed to making effective use of sunlight (solar energy) as a source of energy. Of particular importance has been the need to develop systems that use sunlight to reduce the amount of energy used for lighting and heating domestic and/or commercial properties.

Solar power systems for collecting thermal energy from the sun or for converting sunlight into electrical energy are known. However, such systems are typically required to be added to an existing structure of a property, are difficult to install, and/or cause undesirable changes a structure to which they are added. Traditionally solar thermal collection system are installed on roofs of buildings, in order to collect solar energy used to heat a fluid, which in turn may be employed to heat water and/or the air inside the buildings. Similarly, photovoltaic panels are usually mounted onto existing roofs, or more recently, integrated therein, and generate electricity for use with for example heat pumps coupled to air-fluid heat exchange modules. The latter are usually stand-alone units that force air through heat exchange modules by high velocity fans. In particular the latter are causing concerns due to the noise level they generate, and the difficulty to incorporate them into existing buildings, resulting in positions.

In any case, at least part of these systems are typically mounted onto existing roofs and/or walls with mounting brackets or other hardware, and are typically not integrated into the structure of the building and are not able to efficiently collect and provide solar energy to the building.

More recently, photovoltaic panels have emerged which have thermal fluid exchanger directly installed onto the underside of the panels. While this allows to transfer heat from the photovoltaic panels to the fluid circulating in the heat exchange module, a disadvantage is the rather complex panel, which combines electrical connections and fluid conduits and connections, which makes these modules and panels complex to produce, install and operate.

Also, the direct heat exchange of panel may reduce the efficiency, as using panels for cooling in summer, by sending warm fluid through them, whereas extracting hat in winter may result in ice formation, hence strongly reducing the efficiency of the photovoltaic modules.

Accordingly, there appears room for a less complex, yet equally efficient combined photovoltaic thermal system, which may be advantageously being integrated into buildings, for example roof or façades.

### SUMMARY OF THE INVENTION

The present invention relates to the field of integrated solar-panel roofing systems, in particular photovoltaic systems for tiled surfaces, such as roofs. More specifically the present invention provides a building-integrated solar-panel roof elements comprising one or more photovoltaic panels for integration into pitched roofs, as well as a heat exchange system positioned underneath, but not in physical direct contact with the panels, as well as such a building-integrated roof elements fitted with a photovoltaic panel, and an array of these solar energy roof elements mounted on a pitched roof. Accordingly the present invention relates to solar thermal energy collection systems for building integration. More specifically, it relates a system that collects solar energy from the solar spectrum as electricity, and using the same system for providing an air-fluid heat exchange via a thermal heat exchange module positioned in therein.

In a first aspect the present invention relates to a building integrated thermal and photovoltaic cladding system comprising:
an exterior layer comprising one or more photovoltaic panels,
an interior layer comprising one or more air-fluid heat exchange modules; and
a load-bearing structure configured to maintain the exterior layer in spaced apart relation to the interior layer, and providing an air flow conduit therebetween for receiving air from the exterior and allowing the air flow to generally pass over the interior layer by natural circulation.

Preferably, the system further comprises at least an air vent at each photovoltaic elements in the exterior layer, the vent generally disposed at or near the lower end of each photovoltaic element; and a venting opening generally disposed at the lower end of the system, the venting opening configured to disperse and/or utilize the air flow, each air vent in in fluid flow communication with the air flow channel and the venting opening.

Advantageously, the heat exchange modules are configured to receive and positioned in the air flow of the vented air to pass across the heat exchange modules, and a fluid piping system configured to transfer a heat exchange fluid through the heat exchange modules.

Advantageously, the piping system comprises connection pipes comprising standard connectors for removably connecting one or more heat exchange modules to the piping system.

Advantageously, the piping is further connected to a heating and/or cooling system comprising a heat pump, the heat pump preferably connected to a secondary fluid system in fluid connection to a building HVAC system.

Advantageously, the upper layer comprises a frameless photovoltaic assembly for incorporation into a roof or façade cladding, the assembly comprising:

(i) a photovoltaic panel comprising a transparent top sheet and a backsheet, and one or more photovoltaic cells positioned between the top and backsheet;
(ii) two side elongate elements extending vertically along the sides of the panel;
(iii) an upper elongate sealing element extending in a horizontal direction, and attached to an upper end of the side elongate elements and above the photovoltaic panel,
(iv) a lower elongate sealing element extending horizontal direction and attached to the panel in horizontal direction on the underside of the panel and configured to allows for air venting from the system to pass through.

Advantageously, the photovoltaic assemblies are mounted on a pitched roof with the side walls of adjacent side-by-side assemblies in a facing relationship such that a laterally extending side element interlinks with an adjacent side element, thereby forming a weather-sealing flashing portion, wherein the assemblies are each secured to the roof construction by retaining elements engaging the side elements; and wherein the assemblies are further connected on the downward facing surface to form a photovoltaic electric grid.

Also advantageously, the load-bearing structure comprises a supporting portion for supporting retaining elements on a batten of the building structure, an upper portion for engaging with the exterior layer, and a lower portion for supporting the heat exchange modules positioned spaced apart in an interior layer, and further comprising apertures for allowing passages of the electrical grid wiring and the fluid piping.

Preferably, the retaining elements form a metal profile fastened to a batten of the roof or wall cladding construction.

Advantageously, the piping system comprises at least a coaxial heating-and-cooling tube connected directly to and communicating between each heat exchange module.

In a preferred embodiment, the system comprises at least one photovoltaic module as an exterior layer, and defining a heat recapture gap below the photovoltaic module, wherein the heat recapture gap is sized to allow for fluid flow between the exterior layer and the interior layer, and a heat exchange module for capturing heat when in heat absorption mode, or radiating heat when in cooling mode, through the heat capture gap to the air flow.

Advantageously, the heat exchange module comprises a plurality of elongated members aligned in one direction that are joined by a plurality of connectors aligned in an orthogonal direction.

In a second aspect, the present invention also relates to a method for sustainably generating energy and providing to an air conditioning to a building interior, the method comprising the steps of:
providing a system according to the invention;
collecting electrical energy from the photovoltaic component;
using at least part of the electrical energy to circulate a heat transfer fluid through the heat changers in interior layer, and absorbing heat from, or radiating heat into the air flowing by natural circulation through the gap between the underside of the photovoltaic module layer and a top surface of the heat exchange module structure, and using the heat differential in the heat transfer fluid to drive a heat pump providing energy to a secondary fluid system.

Preferably, the method further comprises the step of heating of cooling the interior of a building through the secondary fluid system.

In a third aspect, the present disclosure also relates to load-bearing structure according for mounting a building integrated thermal and photovoltaic cladding system according to the disclosure, comprising
at least first and second shaped profile sheet metal beams arranged side by side and in-parallel with each other to define a plane, each profiled sheet metal beam having a closed configuration of side walls along its longitudinal axis defining a hollow cross-section perpendicular to its longitudinal axis;
a transverse support comprising two or more notches located in its upper edge;
two or more first sheet metal brackets, each first sheet metal bracket having an outer cross-sectional shape substantially conforming to an inner cross-sectional shape of a corresponding notch in the transverse support, having an inner cross-sectional shape substantially conforming to the outer-cross sectional shape of a corresponding hollow sheet metal beam, positioned in the corresponding notch in the transverse support, and attached to and supporting the corresponding hollow sheet metal beam at least partially within the corresponding notch in the transverse support to capture the hollow sheet metal beam within the first sheet metal bracket;
one or more second sheet metal configured to couple to a photovoltaic panel or photovoltaic panel assembly to position and attach the photovoltaic panel or photovoltaic panel assembly to the photovoltaic panel rack in a desired location in the plane defined by the metal beams;
a portion of the beams arranged to support one or more heat exchange modules in a spaced apart relationship below the exterior layer.

The present disclosure provides a building-integrated modular solar-panel roof element, in particular a photovoltaic roof element, comprising the panel that can be integrated in a pitched roof, as well as such a building-integrated roof element fitted with a photovoltaic panel, and an array of these solar energy roof elements mounted on a pitched roof. The panels according to the disclosure in particular make use of the strength and resilience of photovoltaic panels, in particular those prepared as a sandwich construction comprising both top and backsheet prepared from glass, which in principle has a similar, if not superior resistance to weathering conditions as ceramic roof tiles, and does not necessitate the use of a dedicated frame.

Also, the roof element according to the disclosure has the benefit of being much lighter than those disclosed in the prior art that make use of rigid frames, and due to the generally flat surface area allows adaptation to various different roof tiles or shingles, simply by adapting the size and shape of the upper and lower polymeric weathering strips.

The disclosure also provides a building integrated system roof element which is in principle compatible to any kind of roofing tiles. Yet further, each panel of the system can be easily dismounted but also mounted back, without disrupting the other elements making up the complete covering of the roof; and is weather-and waterproof; and can be made to any convenient size which combines ease of handling with reduced installation costs.

### BRIEF DESCRIPTION OF THE DRAWINGS

The disclosure will be further described by way of example with reference to the accompanying schematic and exemplary drawings, in which:

FIG. 1 is a perspective view from above a preferred system (1).

FIG. 2A to E are side views of preferred embodiments of the system according to the disclosure.

FIG. 3A to Care side views are side views of preferred embodiments of the system according to the disclosure.

FIG. 4 is a perspective view of a titled roof comprising the system, showing the elements.

FIG. 5 is a perspective view of a titled roof comprising the system, showing the visible exterior.

### DETAILED DESCRIPTION

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

When the term “about” is used in describing a value or an endpoint of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. The transitional phrase “consisting essentially of limits the scope of a claim to the specified materials or steps and those that do not materially affect the basic and novel characteristic(s) of the claimed disclosure. Where applicants have defined an disclosure or a portion thereof with an open-ended term such as “comprising,” it should be readily understood that unless otherwise stated the description should be interpreted to also describe such a disclosure using the term “consisting essentially of”.

Use of “a” or “an” are employed to describe elements and components of the invention. This is merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof.

In describing and/or claiming this invention, the term “copolymer” is used to refer to polymers formed by copolymerization of two or more monomers. Such copolymers include dipolymers, terpolymers or higher order copolymers.

Typical photovoltaic elements according to the invention preferably have a layer sequence as follows: a top sheet comprising a textured front sheet and a pigmented layer adjacent and adhered thereto, an encapsulant polymer layer, a photovoltaic cell, an encapsulant layer and a back sheet.

According to a main aspect, the invention relates to a system comprising:
(i) a plurality of laterally extending photovoltaic panels;
(ii) a plurality of mounting members, each member configured to rest on the underlying building construction and extending upwardly towards a laterally extending mounting rail configured for connecting to the mounting members, thereby defining a first distance (A) from the underlying building construction to the laterally extending mounting rail; and
(iii) a plurality of laterally extending mounting rails configured for connecting to the mounting members, and configured for mounting and supporting each photovoltaic panel; and
(iv) one or more a first mounting bracket positioned on a laterally extending mounting rail for mounting and supporting each photovoltaic panel, the one or more mounting brackets being connected to the laterally extending mounting rails and extending outwardly from the laterally extending mounting members;
wherein photovoltaic panels, when mounted in the assembly, are connected to a first mounting member by a first mounting bracket such that each panel is positioned at a sloping angle in relation to the building structure, and overlapping the upper end of a lower panel, thereby forming a scale-like exterior layer; and
wherein the one or more air-fluid heat exchange modules are mounted by a retaining element to the laterally extending mounting rail and/or the mounting members in a position underneath the exterior layer at a position defined by a second distance to the building structure (B), forming the interior layer being spaced apart from the underside of the exterior layer by a third distance (C) defined by the height of the laterally extending mounting member and the underside of the photovoltaic module.

The photovoltaic modules or panels for use according to the invention preferably are frameless, which offers the benefit of minimalizing the use of mounting systems that might shade the cells in the module, such as conventional mounting frames from traditional rooftop mounting systems, for example. Also, the clearance around the edges of the module and the cells in the module is increased and can be chosen such as to account for the module-intruding shading and the shading caused by the height of the mounting elements as the sun moves throughout the day and season. Yet further, the absence of exposed frame parts reduces shadowing under shallow angles, and collection of dirt that may impact incandescence and durability, in particular on lowly pitched roof surfaces.

In the preferred assembly, each photovoltaic roof element is arranged so that one, or a plurality of the elements can be integrated in a pitched roof with the side walls of adjacent side-by-side elements in inter-engaging relationship and with the top and bottom edges respectively of adjacent lower and upper elements overlapping and inter-engaging with one another, the elements can be mounted on the roof by means of fitting brackets engaging with the side elements of the elements, to form a generally planar solar panel array. The mounting in the brackets preferably is performed by a pressure retainer, for example without the use of screws or nails, hence reducing the risk of damaging the electrical cabling while screwing that could cause fire or short circuiting upon use.

Another aspect of the invention is an array of integrated photovoltaic elements and underlying heat exchange modules set out above and mounted on a pitched roof, or a wall cladding.

Yet another aspect of the invention resides in a panel comprising photovoltaic cells for mounting with the roof construction. Yet another aspect of the invention resides in the side elements for affixing photovoltaic cells for mounting with the side elements.

The invention is particularly suitable for use on tilted or sloped rooves, but may equally be employed for façade linings. The incline of the line of slope should be at least so great that the water which hits the corresponding part of the building envelope cannot penetrate, but runs off exclusively to the outside; and that the air that circulates between the layers can circulate by natural circulation.

Advantageously, the system or assembly to the invention further comprises:
at least an air vent at each photovoltaic panels in the exterior layer, the air vent generally disposed at or near the lower end of each photovoltaic element; and
a venting opening generally disposed at the lower end of the exterior layer, the venting opening configured to disperse and/or utilize the air flow, each air vent in in fluid flow communication with the air flow channel and the venting opening.
   Advantageously, in the system or assembly to the invention, preferably the one or more heat exchange modules are fluidly connected to a heating and/or cooling system comprising an electrically driven heat pump, the heat pump preferably connected to a secondary fluid system in fluid connection to a building HVAC system.
   Advantageously, in the system or assembly to the invention, preferably the heat exchange modules are configured to receive, and are positioned in fluid connection with the air flow of the vented air passing across at least one surface of the heat exchange modules, and further comprising a fluid piping system configured to transfer a heat exchange fluid through the heat exchange modules.
   Advantageously, in the system or assembly to the invention, preferably the piping system comprises connection pipes comprising standard connectors for removably connecting one or more heat exchange module to the piping system, preferably at predefined positions aligned with the laterally extending mounting members.

Advantageously, in the system or assembly to the invention, preferably the one or more heat exchange modules are fluidly connected to a heating and/or cooling system comprising a heat pump through fluid piping. Advantageously, in the system or assembly to the invention, preferably the piping system comprises at least a coaxial heating-and-cooling tube connected directly to and communicating between each heat exchange module.

Advantageously, in the system or assembly to the invention, preferably the heat pump comprises an electrically driven pumping device. Preferably the heat pump is connected to a secondary fluid system in fluid connection to a building HVAC system.

Advantageously, in the system or assembly to the invention, preferably the exterior layer comprises a frameless photovoltaic panel assembly for incorporation into a roof or façade cladding, the assembly comprising: (i) one or more photovoltaic panels comprising a transparent top sheet and a backsheet, and one or more photovoltaic cells positioned between the top and backsheet; (ii) sealing elements extending vertically along the sides of each panel; and (iii) an upper elongate sealing element extending in a horizontal direction, and attached to an upper end of the side elongate elements and above the photovoltaic panel, (iv) a lower elongate sealing element extending horizontal direction and attached to the panel in horizontal direction on the underside of the panel and configured to allow for air venting from the system to pass through, thereby forming an air vent.

Advantageously, in the system or assembly to the invention, preferably the photovoltaic panels are connected on the downward facing surface to form a photovoltaic electric grid. Advantageously, in the system or assembly to the invention, preferably the load-bearing structure comprises a supporting portion for supporting retaining elements on a batten or surface of the building structure, an upper portion for engaging with the exterior layer, and a lower portion for supporting the heat exchange modules positioned spaced apart in an interior layer, and further comprising apertures for allowing passages of the electrical grid wiring and the fluid piping.

Advantageously, in the system or assembly to the invention, preferably the laterally extending mounting members form a metal profile fastened to mounting members.

Advantageously, in the system or assembly to the invention, preferably each laterally extending member comprises a body forming a hollow essentially triangular or rectangular frame and an extended section aligned with one side of the frame and shaped to comprise two laterally extending side channels in the rectangular frame.

Advantageously, in the system or assembly to the invention, preferably the second and third distances B and C, respectively, are defined to allow for air flow between the exterior layer and the interior layer by natural convection, and wherein the first and second distances A and B, respectively, are defined to position a heat exchange module with sufficient capacity for capturing heat when in heat absorption mode, or radiating heat when in cooling mode through the heat capture and venting gap in the air flow.

Preferred distances A range of from 5 cm to 30 cm, more preferably of from 8 to 25 cm, yet more preferably of from 9 to 20 cm. Preferred distances B range of from 5 cm to 15 cm, more preferably of from 6 cm to 12 cm, yet more preferably of from 7 to 9 cm. Preferred distances C range of from 0,5 cm to 10 cm, more preferably of from 1 to 8 cm, yet more preferably of from 1,5 to 5 cm.

Advantageously, in the system or assembly to the invention, preferably the fluid heat exchange module comprises a plurality of elongated members aligned in one direction that are joined by a plurality of connectors aligned in an orthogonal direction, allowing for circulation of the heat transfer fluid.

The term “first layer” and “second layer” refers to any layer of the module that is present in the direction of the incandescent light. The layer may be the layer that is directly in contact with the glass or front sheet, as the pigmented coating layer, or may be an intermediate layer. In this respect, the next layer refers to a layer further down in the direction of the incandescent light. The layers may be directly adjacent to each other, or may be separated by further intermediate layers.

### Exterior Layer

The exterior layer is preferably comprised of photovoltaic panels as out above, and the members holding and mounting the panels in place.

### Photovoltaic Panel

Any suitable type of photovoltaic panel can be fitted in the assembly according to the invention. Usually the photovoltaic panel comprises a glass or transparent or translucent outside panel supporting on its rear face a photovoltaic material or cells. Many photovoltaic panels use wafer thin crystalline silicon cells, or thin films based on cadmium telluride or silicon, for example. Generally, any of the commercially available photovoltaic panels can be used. Electrical connections to the photovoltaic elements may be made by conductors extending for example from one or two holes in the underside of the panel.

The encapsulated photovoltaic element includes a top layer material at its top surface, i.e. facing the direction of the incandescent light, and a bottom or backing layer material at its bottom surface. The top layer is comprised of a textured top sheet, with the texture pointing inwardly, and pigmented coating layer adhered to the textured side of the top sheet.

### Top Sheet

The top sheet may comprise a layer material may, for example, provide environmental protection to the underlying photovoltaic cells, and any other underlying layers. Examples of suitable materials for the top layer material include any suitable transparent material, for example polymeric materials, in particular epoxy, (meth)acrylate or polycarbonate materials, or fluoropolymers, for example ETFE, PFE, FEP, PCTFE or PVDF. The top layer material however preferably is a transparent glass or ceramic sheet. Thin hardened and highly transmissive glass or glass ceramic sheets are particularly preferred. Such glass sheets advantageously are provided with a micro-texture at one side, which can then be coated with the pigmented layer. Such panels are particularly long-lived and best withstand weather effects. To produce photovoltaic energy, the panel is at least in part equipped with photovoltaic cells. These preferably have a square or rectangular shape and are housed in the photovoltaic cell region of the panel. They can completely cover the surface. But versions of arrangements are also possible in which the photovoltaic cells have a certain mutual distance so that some of the sunlight is passed through the panel. The photovoltaic cell region is typically square and has a certain distance to the edge of the panel. The edge region which surrounds the photovoltaic cell region is dimensioned according to the required overlapping of the installed panels, for example a few centimetres.

The top sheet may further include at least one antireflection coating, for example as the top layer material, or disposed between the top layer material and the photovoltaic cells.

Preferably the top sheet, facing the incoming radiation has a thickness of between 1.5 and 4 mm. Preferred are glass sheets, which may for example be float glass or roll glass having a texture structure applied at least to one side of the sheet. The glass sheet may optionally be thermally treated. The glass sheet may comprise sodium free glass, for example alumina silicate or borosilicate glass. For large volume production it is preferred to use a soda lime glass or borosilicate glass.

Preferably the top sheet, facing the incoming radiation has a thickness of between 1.5 and 4 mm. Preferred are glass sheets, which may for example be float glass or roll glass having a texture structure applied at least to one side of the sheet. The glass sheet may optionally be thermally treated. The glass sheet may comprise sodium free glass, for example alumina silicate or borosilicate glass. For large volume production it is preferred to use a soda lime glass or borosilicate glass. The soda lime glass may comprise between 67-75% by weight SiO₂, between 10-20% by weight; Na₂O, between 5-15% by weight CaO, between 0-7% by weight MgO, between 0-5% by weight Al₂O₃; between 0-5% by weight K₂O, between 0-1.5% by weight Li₂O and between 0-1%, by weight BaO. Such a glass will suitably have a transparency of higher than 90%. Suitably the glass has been subjected to a thermally toughening treatment after the texture has been applied.

The surface of the glass layer, especially the surface not facing the pigmented coating layer and facing the incoming radiation may be preferably coated with a suitable anti-reflection layer. The anti-reflective layer will limit the radiation which reflects at the glass surface. Limiting this reflection will increase the radiation passing the glass element which will as a result enhance the efficiency of the glass element to transmit radiation. Preferably the coating is applied to one glass layer, namely the glass layer which will in use face the incoming radiation, i.e. sunlight. A suitable anti-reflection coating will comprise of a layer of porous silica. The porous silica may be applied by a sol-gel process as for example described in US-B-7767253. The porous silica may comprise of solid silica particles present in a silica-based binder. Processes to prepare glass layers having an anti-reflective coating are for example described in WO-A-2004104113 and WO-A-2010100285.

Preferably, the photovoltaic element may comprise as follows: i.a light transmissive, coloured top sheet comprising a. a textured transparent front cover sheet; and b. a pigmented top coating layer disposed on the backside of the top sheet with respect to the direction of the incandescent light; ii. a first encapsulant layer iii. one or more photovoltaic cells, each comprising at least one photovoltaically active surface and comprising two electrically conductive electrode layers with a photovoltaic material disposed between them; iv. a second encapsulant layer, and v. a back cover sheet.

The side facing the optional pigmented coating layer is provided with a micro-texture. The actual geometry of the texture is not important, as long as it allowed the top sheet when coated to give the desired birefringent colour appearance. Typical textures comprise dimples, pyramidal structures, grids and the like, such as for instance disclosed in EP-A-1774372 or EP-A-2850664. The concentration of the pigments in the top sheet pigmented layer may depend on the chosen colour effect of the module. Some pigments or pigment combinations are more effective and will require a lower concentration in the layer and some compounds will require a higher concentration because they are less efficient in the desired colour tone.

The encapsulated photovoltaic element may comprise other layers interspersed between the top layer material and the bottom layer material. For example, the encapsulated photovoltaic element can include structural elements, such as a reinforcing layer of glass, metal or polymer fibres, or a rigid film; adhesive and encapsulant layers, such as EVA to adhere other layers together; mounting structures, such as clips, holes, or tabs; and one or more optionally connectorized electrical cables for electrically interconnecting the photovoltaic cell(s) of the encapsulated photovoltaic element with an electrical system.

A photovoltaic module or element according to the invention may be prepared by stacking the different layers of the top sheet and the photovoltaic cell, additional encapsulant layer or layers and a backsheet layer and subjecting the formed stack to a lamination process step.

Prefearbly, the method further comprises c) providing a stack comprising the light transmissive coloured top sheet obtained; a first encapsulant material; one or more photovoltaic cells comprising at least one photovoltaically active surface and comprising two electrically-conductive electrode layers with a photovoltaic material disposed between them; a second encapsulant material, and ii.) subjecting the stack obtained in i.) to a suitable pressure and temperature, to obtain a photovoltaic element.

To carry out encapsulation, a laminating encapsulant film, and a top sheet, for instance a coated glass sheet, for example a low-iron soda-lime glass, are positioned over the photovoltaic module having integrated serial connection, and a second encapsulant sheet and a backsheet are laid down and subsequently laminated in a thermal curing step. Typical lamination temperatures are in the range from 50 to 200° C. The lamination temperature may be between 100 and 175° C. and wherein the environment of the stack preferably has a pressure of less than 30 mBar, more preferably less than 1 mBar. In this process the stack is preferably present in a vacuum laminator and pressure bonded under conversion heating at a temperature in the range of from of 100 to 175° C., preferably 110 to 165° C., most preferably from 115 to 155° C. The laminate is preferably also subjected to degassing. The compression lamination pressure preferably is in the range of from of 0.1 to 1.5 kg/cm². The lamination time typically is in the range of from 5 to 25 minutes. This heating enables for example the ethylene-vinyl acetate copolymer contained in the polymer sheet according to the invention and in the encapsulant layer to crosslink, whereby the photovoltaic cell, the polymer sheet and the encapsulant layer are strongly adhered to seal the photovoltaic cell and obtain the photovoltaic module according to the invention. Where “dummy” modules are desired with the same appearance the above process is repeated, however omitting the photovoltaic cells.

Encapsulated photovoltaic element include a textured top protective layer comprising coating layer; for example, a coated glass sheet; a first encapsulant layer, preferably comprising POE, functionalized POE, EVA, functionalized EVA crosslinked EVA, silicone, thermoplastic polyurethane, maleic acid-modified polyolefin, ionomer, or ethylene/(meth)acrylic acid copolymer); a layer of electrically-interconnected photovoltaic cells; a optionally pigmented back encapsulant layer; and a backing sheet layer, such as glass, aluminium, PVDF, PVF, or PET.

The present invention can be practiced using any of a number of types of architectural substrates. For example, in certain embodiments of the invention, the top surface of the roofing substrate is polymeric (for example, a polymeric material, or a polymeric coating on a metallic material).

In other embodiments of the invention, the back surface of the element may be metallic.

In other embodiments of the invention, the back surface of the element is coated with roofing granules, such as for instance a bituminous material coated with roofing granules. In other embodiments of the invention, the back surface of the roofing substrate is bituminous such as an uncoated bituminous roofing substrate.

The pigmented and thus coloured coating layer is preferably designed to resemble a natural material such ceramics or stone, or other manmade materials such as ceramic or concrete, or to blend in with the environment, for example when used for noise barrier along roads or highways.

Applicants found that the combination of the textured top sheet and the presence of plate-like pigments results in a birefringent colour effect, at a relatively low adsorption rate. In particular, the top sheet including the coloured coating layer forms a birefringent multilayer optical film having an angularly dependent appearance. The colour-shift effect of layer can be further modified by adjusting the reflectance or absorbance behaviour of the layers beneath the birefringent optical film.

### Pigments

Suitable pigments may comprise pearlescent pigments, nacreous pigments, metal flake pigments or encapsulated metal flake pigments. In particular, light-interference platelet pigments are known to give rise to various optical effects when incorporated in coatings, including opalescence or pearlescence. Particularly preferred are multilayer interference pigments consisting of a carrier material coated with alternating layers of metal oxides of high and low refractive index, the layer(s) of the metal oxide of low refractive index being optically inactive. Preferably, the carrier material is mica, another phyllosilicate, glass flakes, or platelet-form silicon dioxide. Preferred are also pigments that comprise an additional coating with complex salt pigments, especially cyanoferrate complexes, for example Prussian Blue and Turnbull's Blue. The pigment may also be coated with organic dyes and, in particular, with phthalocyanine or metal phthalocyanine and/or indanthrene dyes. This is done by preparing a suspension of the pigment in a solution of the dye and then bringing this suspension together with a solvent in which the dye is of low or zero solubility.

The thickness of the interlayers of metal oxides of low refractive index within a metal oxide layer of high refractive index is from 1 to 20 nm, preferably from 2 to 10 nm. Within this range, a metal oxide layer of low refractive index, for example silicon dioxide, is optically inactive, which is an essential feature of the present invention.

The thickness of the layers of metal oxides of high refractive index is between 20 and 350 nm, preferably between 40 and 260 nm. Since the interlayers of low-refractive-index metal oxides greatly increase the mechanical stability of the layers of high-refractive-index metal oxides, it is also possible to prepare thicker layers of adequate stability. In practice, however, layer thicknesses of only up to 260 nm are employed, which in the case of a titanium dioxide-mica pigment would correspond to a 3^{rd} order green aspect.

The inherent colour as well as the interference colour of the interference pigments according to the invention can be varied within a wide range and optimized with a view to the particular application. Thus, for example, the inherent colour can be selectively established by choosing a coloured substrate and/or by using one or more coloured metal oxides as components of the film covering the carrier. The present invention permits to prepare all kinds of colours and appearances, such as green, gold, terracotta, blue, violet, red or orange. just to name a few colours.

The number and thickness of the interlayers is dependent on the total layer thickness of the metal oxide layer of high refractive index. The interlayer is preferably arranged such that the layer thickness of the metal oxide layers of high refractive index corresponds to the optical thickness, or to an integral multiple of this optical thickness, which is necessary for the respective interference colour.

The metal oxide of high refractive index can be an oxide or mixtures of oxides with or without absorbing properties, such as TiO₂, ZrO₂, Fe₂O₃, Fe₃O₄, Cr₂O₃ or ZnO, or a compound of high refractive index such as, for example, iron titanates, iron oxide hydrates and titanium suboxides, or mixtures and/or mixed phases of these compounds with one another or with other metal oxides.

The metal oxide of low refractive index may be selected from SiO₂, Al₂O₃, AlOOH, B₂O₃ or a mixture thereof and can likewise have absorbing or non-absorbing properties. If desired, the oxide layer of low refractive index may include alkali metal oxides and alkaline earth metal oxides as constituents.

Examples of light-interference platelet pigments that can be employed in the pigmented layer of the present invention include light-interference pearlescent pigment based on mica covered with a thin layer of titanium dioxide and/or iron oxide; platelet crystal effect pigment based upon Al₂O₃ platelets coated with metal oxides, multi colour effect pigments based on SiO₂ platelets coated with metal oxides; ultra-interference pigments based on TiO₂ and mica; and mirrorized silica pigments. In one embodiment of the invention, a layer having a metallic or light-interference effect is disposed on a layer having a white reflective pigment (for example, TiO₂ or ZnO₂). This can increase the efficiency of the metallic/light-interference pigments by increasing scattering from the background. In some embodiments, the one or more colorants can themselves have a multilayer structure, such that thin film interference effects give rise to metallic appearance effects or angular metametrism.

Furthermore, it is of course also possible to incorporate small inorganic pigment particles having a particle size of less than 100 nm and in particular 5 to 50 nm into one or, if desired, more of the films. Suitable light-interference platelet pigments may have an equivalent diameter distribution, according to which 90% of the particles are in the range from 2 to 40 μm, preferably from 5 to 40 μm in particular from 3 to 35 μm, very particularly preferably from 5 to 30 μm. In addition to the equivalent diameter distribution, the thickness distribution of the platelets also plays a role. Thus, suitable base substrates preferably have a thickness distribution, according to which 90% of the particles are in the range from 100 to 3500 nm, preferably 200 to 2600 nm, in particular 250 to 2200 nm.

Preferably, the aspect ratio (aspect ratio: diameter/thickness ratio) of the platelets is 5-200, especially 7-150, and most preferably 10-100.

In some embodiments of the invention, the pigmented layer may include one or more additional or alternative pigments, including but not limited to ultramarine blue, ultramarine purple, cobalt chromite blue, cobalt aluminium blue, chrome titanate, nickel titanate, cadmium sulphide yellow, cadmium sulphide yellow, cadmium sulfoselenide orange, and organic pigments such as perylene black, phthalo blue, phthalo green, quinacridone red, diarylide yellow, azo red, and dioxazine purple. Additional pigments may comprise iron oxide pigments, titanium oxide pigments, composite oxide system pigments, titanium oxide-coated mica pigments, iron oxide-coated mica pigments, scaly aluminium pigments, zinc oxide pigments, copper, nickel, cobalt or iron phthalocyanine pigment, non-metallic phthalocyanine pigment, chlorinated phthalocyanine pigment, chlorinated-brominated phthalocyanine pigment, brominated phthalocyanine pigment, anthraquinone, quinacridone system pigment, diketo-pyrrolipyrrole system pigment, perylene system pigment, monoazo system pigment, diazo system pigment, condensed azo system pigment, metal complex system pigment, quinaphthalone system pigment, Indanthrene Blue pigment, dioxadene violet pigment, anthraquinone pigment, metal complex pigment, benzimidazolone system pigment, and the like.

The pigments are added to the coating composition that forms the pigmented layer according to the invention after application in a concentration that is generally suitable for the colour depth and effect to be achieved. Preferably, the pigments according to the invention are present in an amount of from. 0.1 to 80% by weight based on the coating composition, preferably of from 1 to 40%., yet more preferably of from 2 to 15% by weight.

In certain embodiments of the invention, the coloured pigmented layer may also include a coloured, infrared-reflective pigment, for example comprising a solid solution including iron oxide; or a near infrared-reflecting composite pigments. Composite pigments are composed of a near-infrared non-absorbing colorant of a chromatic or black colour and a white pigment coated with the near infrared-absorbing colorant. Near-infrared non-absorbing colorants that can be used in the present invention include organic pigments such as organic pigments including azo, anthraquinone, phthalocyanine, perinone/perylene, indigo/thioindigo, dioxazine, quinacridone, isoindolinone, isoindoline, diketopyrrolopyrrole, azomethine, and azomethine-azo functional groups, and include chromium green-black, chromium iron oxide, zinc iron chromite, iron titanium brown spinel, and chrome antimony titanium.

Preferred black organic pigments include organic pigments having azo, azomethine, and perylene functional groups. Coloured, infrared-reflective pigments can be present, for example, at a level in the range of about 0.1% by weight to about 10 percent by weight of the pigmented layer composition. Preferably, such a coating composition forms a layer having sufficient thickness to provide good colour effect, but at sufficient transparency, such as a thickness of from about 5 μm to about 150 μm.

Applicants found that in spite of the relatively high pigmentation, transmission was not significantly reduced. For instance blue or green coloured photovoltaic modules only showed a reduction in efficiency sa compared to unpigmented muddles of from 5 to 8%, whereas even for a terracotta pigmentation, an efficiency reduction of only about 20% was found. This compares very favourably to pigmented solid glass front sheets, and to encapsulants with pigments therein. Without wishing to be bound to any particular theory, it is believed that the combination of the interference pigments and the texture at the inside of the top sheet form a birefringent composite sheet, which scatters light to the eye of the beholder in a more prominent way that traditional pigmented top layers, while at the same time allowing transmission of sufficient light to maintain a high efficiency.

Advantageously, the present photovoltaic modules can be prepared in almost any colour tone, allowing for a very wide applicability ranging from the apparition close to traditional roof tiles, to noise barriers, to colour tones that blend in with the environment, for example forest or dunes; and colours chosen to enhance architectural features.

Since not all surfaces of a building or other structures need to, or are suitable for providing photovoltaic electricity, the present invention also pertains to panels that are complementary to the elements according to the invention, but entirely or in part void of photovoltaic cells. Such panels accordingly comprise a light transmissive, coloured top sheet comprising a. a textured transparent front cover sheet; and b. a pigmented top coating layer disposed on the inside of the top sheet with respect to the direction of the incandescent light; a first encapsulant layer. a second encapsulant layer, and a back cover sheet. Such “dummy” panels may also be used to cut or shape for suitable roof coverage, for example at corners.

The photovoltaic cell may be monofacial or bifacial. The photovoltaic cells can be based on any desirable photovoltaic material system, such as monocrystalline silicon; polycrystalline silicon; amorphous silicon; III-V materials such as indium gallium nitride; II-VI materials such as cadmium telluride; and more complex chalcogenides (group VI) and pnicogenides (group V) such as copper indium diselenide or CIGS. For example, one type of suitable photovoltaic cell includes an n-type silicon layer (doped with an electron donor such as phosphorus) oriented toward incident solar radiation on top of a p-type silicon layer (doped with an electron acceptor, such as boron), sandwiched between a pair of electrically-conductive electrode layers. Thin-film amorphous silicon materials can also be used, which can be provided in flexible forms. Another type of suitable photovoltaic cell is an indium phosphide-based thermo-photovoltaic cell, which has high energy conversion efficiency in the near-infrared region of the solar spectrum. Thin film photovoltaic materials and flexible photovoltaic materials can be used in the construction of encapsulated photovoltaic elements for use in the present invention. In one embodiment of the invention, the encapsulated photovoltaic element includes a monocrystalline silicon photovoltaic cell or a polycrystalline silicon photovoltaic cell. The photovoltaic cells can be interconnected to provide a single set of electrical contacts for a module. The module according to the invention may also be combined with wafer-based photovoltaic cells based on monocrystalline silicon (c-Si), poly- or multi-crystalline silicon (poly-Si or mc-Si) and ribbon silicon. Preferably the module comprising wafer-based photovoltaic cells will comprise the top sheet according to the invention as front facing in use the incoming radiation, a polymer layer, a layer comprising a wafer-based photovoltaic cell and a back-sheet layer.

Suitable photovoltaic cells may be crystalline silicon cell, CdTe, αSi, micromorph Si or Tandem junction αSi photovoltaic cells.

In certain embodiments of the invention, the photovoltaic cells, the coloured coating layer, and the encapsulant layer may be provided together as an encapsulated photovoltaic element, which can be affixed to the top and back sheet.

Suitable photovoltaic cells and/or photovoltaic elements can be obtained, for example, from several different suppliers, such as China Electric Equipment Group of Nanjing, Uni-Solar, Sharp, USFC, FirstSolar, General Electric, Schott Solar, Evergreen Solar and Global Solar.

Moreover, the person of skill in the art can fabricate encapsulated photovoltaic elements using techniques such as lamination or autoclave processes. The encapsulated photovoltaic elements can be made, for example, using methods disclosed in U.S. Pat. No. 5,273,608, which is hereby incorporated herein by reference.

The top surface of a photovoltaic cell is the surface presenting its photoelectrically-active areas. When installed, the photovoltaic roofing elements of the present invention should be oriented so that the top surface of the photovoltaic cell(s) is illuminated by solar radiation.

The one or more photovoltaic cells have an operating wavelength range. Solar radiation includes light of wavelengths spanning the near UV, the visible, and the near infrared spectra. As used herein, the term “solar radiation,” when used without further elaboration means radiation in the wavelength range of 300 nm to 1500 nm, inclusive. Different photovoltaic elements have different power generation efficiencies with respect to different parts of the solar spectrum. Amorphous doped silicon is most efficient at visible wavelengths, and polycrystalline doped silicon and monocrystalline doped silicon are most efficient at near-infrared wavelengths. As used herein, the operating wavelength range of an encapsulated photovoltaic element is the wavelength range over which the relative spectral response is at least 10% of the maximal spectral response. According to certain embodiments of the invention, the operating wavelength range of the photovoltaic element falls within the range of about 300 nm to about 2000 nm. In certain embodiments of the invention, the operating wavelength range of the encapsulated photovoltaic element falls within the range of about 300 nm to about 1200 nm. For example, for encapsulated photovoltaic elements having photovoltaic cells based on typical amorphous silicon materials the operating wavelength range is between about 375 nm and about 775 nm; for typical polycrystalline silicon materials the operating wavelength range is between about 600 nm and about 1050 nm; and for typical monocrystalline silicon materials the operating wavelength range is between about 425 nm and about 1175 nm.

Photovoltaic cells often have a somewhat metallic appearance, and sometimes have a birefringent colour effect also known as “flop,” i.e. depending on the viewing angle and the illumination angle, the observed colour aspect may change.

To achieve better matching of appearance between the photovoltaic elements and the surrounding substrate upon which they are disposed, in certain embodiments of the invention the back encapsulant layer may be, for example, in the main colour tone that approximates the characteristic dark blue colour of a photovoltaic element.

In certain embodiments of the invention, the coloured top sheet may have a metallic or light-interference effect. Such an effect can help impart a metallic visual effect to the module, so as to better mimic the appearance of the photovoltaic cells.

### Back Sheet

The back sheet may advantageously comprise a hard polymer, such as for example a layer of PET, metal, a composite material, or preferably a further glass layer. When thin film photovoltaic cells are employed, for example CIGS and CIS type cells, the photovoltaic module may advantageously comprise a glass top sheet of the present invention, an encapsulant of the present invention, the thin film photovoltaic cell a second encapsulant layer and a rigid support, such as for example glass.

The back sheet or bottom layer material can be, for example, a fluoropolymer, for example ETFE, PFE, FEP, PVDF or PVF (“TEDLAR”). The bottom layer material may alternatively be, for example, a polymeric material, including polyester such as PET; or a metallic material, such as steel or aluminium sheet, or preferably, a glass sheet.

The back-sheet layer preferably is pigmented, more preferably to resemble the photovoltaic cells, or it may comprise a so-called white reflector. The presence of pigments in the backsheet is advantageous because it will reflect radiation to the photovoltaic cell and thus improve the efficiency of the cell. This is in particular beneficial where bifacial photovoltaic cells are employed.

Possible backsheet layers comprise fluoropolymer layers. Instead of a fluoropolymer layer a second glass sheet may be provided at the back of the solar cell. This will provide a solar cell which has a glass front and backside. The glass layer for use as backside will preferably have a thickness of less than 3 mm.

The glass layers may be as described above. The use of a glass front and backside is advantageous because it provides a structural strength to the panel such that no separate frame is necessary. The glass backside will also provide an absolute barrier towards water ingress and the like which is advantageous for extending the lifetime of the panel. The use of the glass layer will make it possible to avoid the use of a back sheet comprising a fluoropolymer.

One or more of the photovoltaic elements described herein above may be combined to a larger element for installation as part of a photovoltaic system for the generation of electric power.

Accordingly, one embodiment of the invention is a photovoltaic architectural system disposed on a building, noise barrier wall, roof deck or the like, comprising one or more photovoltaic roofing elements as described above disposed thereon. The photovoltaic module may comprise cells that are monofacial or bifacial, or both.

Preferably, the sealing elements comprise a polymeric seal with an asymmetric shape to engage in weather sealing relationship with adjacent roofing component positioned horizontally above, and below, respectively.

The seal may be pre-molded and glued, or molded or glued in situ from suitable material, such as for instance (semi)liquid polyurethane, silicones, or another similar crosslinking material. An alternate attachment method for a seal may utilizes a strip of double-sided tape, the latter including a durable, weather resistant, pressure sensitive adhesive on both its upper and lower surfaces. The shape of the sealing member may be adjusted to the shape of the roof tiles such that a weather-sealing connection is formed.

Preferably, the side elements are shaped and designed to engage a retaining element for retaining the assembly from movement in a direction downward of the building structure.

Preferably, each side frame element is an elongate body comprising at least an outer side portion accommodating for attaching to the retaining element, a panel-engaging portion for accommodating a side edge of the panel.

Preferably, at least one of the side elongate frame element comprises a lateral portion extending from the panel and underneath a laterally positioned roofing component, preferably a further photovoltaic assembly, and comprising at least one upstanding ridge for engaging in weather sealing relationship with an underside of the laterally positioned roofing component.

Preferably, the side elongate frame element opposite to the side element providing a flashing portion comprises at least one upstanding ridge pointing downwardly, for engaging with a flashing portion of a further assembly or a roofing component in a weather sealing arrangement.

Preferably, the side elements comprise reversible holding means for engaging with the retaining element.

Preferably, the reversible holding means comprises a groves with a keyhole shaped opening such that an assembly may be lifted over a retaining pin, preferably a screw heads extending form the retaining element, after which the assembly can be pulled downwards such that the retaining pin slides into the narrower part of the keyhole shaped opening, thereby securing the assembly to the retaining assembly.

Preferably, the side elements are metal extrusion or folded sheet elements, preferably wherein the metal is selected from aluminium alloys, and/or corrosion resistant steel.

Preferably, the upper elongate frame and sealing element is formed integrally with a seal, or comprises a groove for retaining a flange of a seal, such that an overhanging lip is provided for sealing the upper side of the frame with an underside of a preceding roofing element, thereby protecting the cavity formed between the element and the assembly from weather and UV exposure where the sealing occurs.

Preferably, each sealing element includes a glazing polymeric seal with an asymmetric shape, wherein a lip on a lower portion extends beyond the edge of the lower surface and engages with an upper surface to constrain the lip, for catchment and subsequent direction to external drainage of internal or external moisture.

Preferably, the seal comprises an elastomeric material, preferably a UV stable material selected from a natural or synthetic polymer having elastic properties, such as natural or synthetic rubbers, elastomers silicones, and polyolefins.

Preferably, the seal and the side element are shaped to accommodate the shape of a roofing element adjacent to the assembly.

Preferably, the downward facing seal comprises an overhanging lip portion at the top of a curved face that narrows to a fine edge, to form a compliant seal to the lower surface of a roofing material adjacent in a lateral direction, to effect a seal between the upper surface edge and the lower frame element along this joint to water flowing off the external surface of the panel and onto the next surface while prohibiting ingression between the assembly and the and adjacent roofing component.

Preferably, the photovoltaic panel comprises a lateral zone at the top side that is free from photovoltaic cells, and a photovoltaic zone positioned below the free zone, wherein the zone that is free from photovoltaic cells is designed to be installed underneath an overlapping roofing element, preferably a roof tile or a photovoltaic assembly. Preferably, the two side elongate elements extend from the top.

The present invention also relates to a frameless photovoltaic assembly for incorporation into a tiled roof, comprising two or more assemblies, preferably, wherein assemblies are mounted on a pitched roof with the side walls of adjacent side-by-side assemblies in facing relationship, and secured to the roof by retaining elements engaging the side elements; and optionally, wherein the elements are connected to one another to form a photovoltaic electric grid. The term “frameless” refers to a photovoltaic assembly wherein not all four sides of an assembly are embedded in a frame or four-sided supporting structure that connects and holds in place the solar panel in place.

The present invention also relates to a retaining element for engaging with the side elements of the assembly, the element comprising a supporting portion for supporting the retaining element on a batten of the building structure, and an upper portion for engaging with the side element and/or a roofing component. Thus allows to build up the scale-like exterior layer, whereby each photovoltaic panel is on fluid communication with the exterior at its upper end, as well as t the lower end. This advantageously permits to maximize the heat exchange per photovoltaic panel, as for instance hot air can be vented by each photovoltaic panel, without the need to a more complex air ventilation system. The present system was found to show strong benefits over closed layer systems such as those disclosed in DE102011121135A1, since each heat exchanger unit is supported by each overlying photovoltaic panel, and due to the scale-like mounting, fresh air can enter at each panel.

The present invention also relates to a retaining element according to the disclosure, wherein the retaining elements are formed from a thermoplastic or thermosetting polymeric material, and are provided for attaching the assembly to a batten by holding means, preferably holding screws extending through the blocks and into the batten.

The present disclosure also relates to a securing element for engaging with the assembly according to the invention, comprising a supporting portion for supporting the assembly and a retaining element for securing to a batten of the building structure, preferably a wind-hook.

The present invention also relates to a photovoltaic panel for use in the assembly. Preferably, the panel comprises a translucent top layer and a bottom layer with photovoltaic cells affixed between the top and bottom layers for providing solar power, and at least one aperture for allowing a passage to wires, cables and/or tubing for attaching a junction element connecting the photovoltaic panel to an electric grid.

Preferably, the building-integrated thermal and photovoltaic cladding system is configured for installation on a building structure, comprising:
at least one photovoltaic panel (3) having opposing top and bottom edges,
at least one air-fluid heat exchange module (6);
a load-bearing structure comprising:
a plurality of mounting members (7), each mounting member having a distance of height (A) in a z-direction on the z-axis and spaced a distance apart from each adjacent mounting member (7) in a y-direction on the y-axis, wherein the at least one air-fluid heat exchange module (6) is arranged on the y-axis at a position between two adjacent mounting members (7) and spaced a second distance (B) apart from the building structure (2) in the z-direction, and
a corresponding plurality of mounting brackets (5), each mounting bracket (5) arranged on a top surface of a respective one of the plurality of mounting members (7), wherein the at least one photovoltaic panel (3) is mounted between two adjacent mounting brackets and spaced a third distance (C) above the at least one air-fluid heat exchange module (6) in the z-direction, and
an air flow conduit arranged between the at least one photovoltaic panel (3) and the at least one air-fluid exchange module (6), the air flow conduit configured to receive an air flow and to allow the air flow to pass over the at least one air-fluid heat exchange module (6) by natural circulation.

Advantageously, the system further comprises respective first and second mounting rails, wherein the first mounting rail is configured to fittingly secure the top edge of the at least one photovoltaic panel in a recess of the corresponding mounting bracket on a first of the two adjacent mounting members, and the second mounting rail is configured to fittingly engage with the corresponding mounting bracket on a second of the two adjacent mounting members to secure the at least one photovoltaic panel proximal to the bottom edge.

Preferably, the system according to the disclosure, further comprises respective first and second retaining elements, the first retaining element being configured to mount a top edge of the at least one air-fluid exchange module to the corresponding mounting member and/or the corresponding mounting bracket on a first of the two adjacent mounting members, and the second retaining element configured to mount a bottom edge of the at least one air-fluid exchange module to the corresponding mounting member and/or the corresponding mounting bracket on a second of the two adjacent mounting members.

Preferably, the at least one photovoltaic panel comprises an air vent arranged at or proximal to the bottom edge, and a vent opening in fluid communication with the air vent and the air flow; and an air vent arranged at or proximal to the top edge where the panel is positioned underneath a preceding higher arranged panel in an upward direction.

The system advantageously further comprises a fluid piping system configured to transfer a heat exchange fluid through the at least one air-fluid heat exchange module.

Preferably, the fluid piping system comprises connection pipes comprising connectors adapted for removably connecting the at least one heat exchange module to the piping system, preferably at predefined positions aligned with the plurality of mounting members.

Preferably, the fluid piping system comprises at least a coaxial heating-and-cooling tube connected directly to and in fluid communication with the at least one air-fluid heat exchange module.

Preferably, the at least one heat exchange module is fluidly connected to a heating and/or cooling system comprising a heat pump through fluid piping and/or an electrically driven pumping or fluid circulation device. Preferably the heat pump is connected to a secondary fluid system in fluid connection with a building HVAC system.

Preferably, the at least one photovoltaic panel comprises a frameless photovoltaic panel assembly for incorporation into a roof or façade cladding, the frameless photovoltaic panel assembly comprising:
at least one photovoltaic panel comprising a transparent top sheet, a backsheet, and one or more photovoltaic cells positioned between the top sheet and backsheet;
side elongate elements extending vertically along lateral side edges of the at least one photovoltaic panel;
an upper elongate sealing element extending along the top edge of the photovoltaic panel and attached to an upper end of each side elongate element,
a lower elongate sealing element extending along the bottom edge of the photovoltaic panel and attached to an underside of the photovoltaic panel, the lower elongate sealing element configured to allow for air venting from the system to pass through, thereby forming an air vent.

Preferably, he photovoltaic panel comprises (a) a top sheet, optionally comprising a pigmented coating layer; (b) a front encapsulant material; (c) an array of photovoltaic elements, (d) a layer of electric connectors; (e) a back encapsulant material; (f) a backsheet, and (g) at least one connector for connecting the panel to an electric grid.

The present invention also relates to a roof comprising an assembly according to the invention, and at least one electrical convertor for converting the photovoltaic electricity to electricity that can be fed into a residential electricity grid.

The present invention also relates to a kit of parts comprising at least one assembly according to the description, and at least one retaining system.

The photovoltaic elements of the photovoltaic roofing elements are desirably connected to an electrical system, either in series, in parallel, or in series-parallel, as would be recognized by the skilled artisan. There can be one or more layers of material, such as underlayment, between the roof deck and the photovoltaic roofing elements of the present invention.

The photovoltaic roofing elements of the present invention can be installed on an existing building or roof; in such embodiments, there may be one or more layers of “dummy” i.e., non-photovoltaic cladding elements that have the same built-up, but are void of photovoltaic cells, but provide essentially the same optical effect and protection from the environment, and the photovoltaic elements according to the present invention.

Photovoltaic elements of the present invention can be fabricated using many techniques familiar to the skilled artisan. It will be apparent to those skilled in the art that various modifications and variations can be made to the present invention without departing from the scope of the invention. Thus, it is intended that the present invention cover the modifications and variations of this invention provided they come within the scope of the appended claims and their equivalents.

In contrast to many known photovoltaic roof constructions, the construction as claimed in the invention does not require two separate frame envelopes. Rather weather protection and energy recovery are combined into a single panel, specifically in the assembly arranged as claimed in this specification.

In this case panels are called “directly adjacent” which overlap over a certain length of the edge region. Panels are called “indirectly adjacent” which are typically next to one another at the same height with respect to the line of slope, but do not overlap.

It is desirable for the roof of a building to exhibit a uniform impression. The panel system according to the invention therefore may include not only panels with, but also those without photovoltaic cells, and roof tiles.

The panels with photovoltaic cells may be installed at sites of the building exposed to the sun and the panels without photovoltaic cells, or roofing tiles on the side facing away from the sun.

Furthermore, in the system there are also tiles, or panels which are free of photovoltaic cells for the edge termination of the roof. These panels may be of any shape, for example triangular. The shape of these panels can arise by division of the regular panel shape parallel to a diagonal line into two unequal parts.

The panel shape is generally a rectangular shape, but square or other shapes are also possible. As is apparent from the aforementioned explanations, the system is not however limited to these panels.

### Interior Layer

The interior layer is formed by the heat exchange modules, which are mounted in the laterally extending members at a distance from the exterior layer that allows for air circulation to take place between the two layers. The interior layer may be a continuous layer, or may only be present in part, whereby then the underlying building structure may act as art of the interior layer. The space between the exterior photovoltaic panels, and the interior heat exchange modules may be chosen suitably for the amount of heat to be extracted or dissipated, and for sufficient air flow. The heat exchange modules may be mounted by simple retaining brackets, or simply by screwing them to the mounting members.

### Heat Exchange Module

Various different heat exchange modules may be employed, such as block or plate liquid heat exchange modules with microchannel plates in a housing. According to a preferred embodiment of the invention, the heat exchange module represents a fluid-to-air heat exchange module in the form of a plate and fin type heat exchange module formed of a plurality of stacked tubular members having a first set of flow channels for the flow of the fluid through the heat exchange module. The plurality of stacked tubular members are preferably spaced apart from each other to form a second set of flow channels for the air through the heat exchange module, whereby the air may flow through the heat exchange module in a direction transverse to the flow of the heat exchange fluid. Since the laterally extending members are spaced a regular intervals, standardly dimensioned heat exchange modules may advantageously be employed, and also, a standardised piping may be included, allowing a quick and fast exchange, removal or addition of heat exchange modules. The heat exchange modules may advantageously allow the flow of air not only over the surface thereof, but in particularly suited ae modules that allow the air to also flow through the modules heat exchange surfaces. Accordingly, the present invention also includes systems where the heat exchange modules form an interior layer that comprises at least part of the air flow gap.

### Piping and Connectors

Standard piping and tubes may be employed as presently known for air-fluid exchangers, such as those used for instance in automotive vehicles, or otherwise. Preferably, the laterally extending members already comprise channels and openings to allow of a standardized piping to be channelled through. Also, since the temperatures of domestic heat pumps are usually not going above 120° C., materials and connectors can be chosen as usually employed in such systems, or even in warm or in drinking water piping.

### Heat Pump

A thermoelectric heat pump system for use in the present system in accordance with the invention may be operable in a cooling and/or heating mode. The system preferably comprises a thermoelectric apparatus and a liquid heat exchange module block apparatus thermally coupled to a first side of the thermoelectric apparatus. The liquid heat exchange module block apparatus includes at least one passage for flow of a heat transfer liquid therethrough. The system includes a radiator for rejecting heat from the heat transfer fluid when the thermoelectric pump system operates in a cooling mode and absorbing heat in the heat transfer fluid when the thermoelectric pump system operates in a heating mode. A convective fan associated with the radiator increases the heat transfer coefficient of the radiator. A conduit system couples the liquid heat exchange module block apparatus and the radiator for circulating the heat transfer fluid between the liquid heat exchange module block apparatus and the radiator. A second side of the thermoelectric apparatus opposite from the first side is thermally coupled to a heat source when the thermoelectric heat pump system operates in a cooling mode or to a cold source when the thermoelectric heat pump system operates in a heating mode. The thermoelectric apparatus can be powered to pump heat from the heat source in the cooling mode and pump heat to the cold source in the heating mode.

In accordance with one or more embodiments, a single or multistage liquid loop thermoelectric heat pump system for cooling and/or heating is disclosed that can achieve higher delta temperature and COP then previous thermoelectric heat pump systems. Various embodiments disclosed herein utilize liquid to air heat exchange modules, which have a higher heat transfer coefficient of 350 W/m² K and therefore are more efficient at absorbing or rejecting heat compared to thermoelectric heat sinks, which have a heat transfer coefficient of 100-150 W/m²K.

The heat pump part preferably comprises a thermoelectric apparatus; a fluid-fluid heat exchange module block apparatus thermally coupled to a first side of the thermoelectric apparatus, the fluid heat exchange module block apparatus including at least one passage for flow of a heat transfer fluid therethrough; a radiator for rejecting heat from the heat transfer fluid when the thermoelectric pump system operates in a cooling mode and absorbing heat in the heat transfer fluid when the thermoelectric pump system operates in a heating mode; and a convective fan associated with the radiator for increasing the heat transfer coefficient of the radiator; and a conduit system coupling the liquid heat exchange module block apparatus and the radiator for circulating the heat transfer fluid between the liquid heat exchange module block apparatus and the radiator; wherein a second side of the thermoelectric apparatus opposite from the first side is thermally coupled to a heat source when the thermoelectric heat pump system operates in a cooling mode or to a cold source when the thermoelectric heat pump system operates in a heating mode, wherein the thermoelectric apparatus can be powered to pump heat from the heat source in the cooling mode and pump heat to the cold source in the heating mode.

### HVAC

Heating, ventilation, and/or air conditioning (HVAC) systems are often used to control the comfort level within a building or other structure. Such HVAC systems typically include an HVAC controller that controls various HVAC components of the HVAC system in order to affect and/or control one or more environmental conditions within the building. Such HVAC controllers typically have a user interface for allowing a user to interact and the HVAC controller.

Suitable HVAC systems may include one or more HVAC components for providing conditioned air to one or more HVAC ducts of the building and a plurality of electronically controllable register vent dampers for controlling delivery of the conditioned air from the one or more HVAC ducts into the building. In some cases, each of the plurality of electronically controllable register vents may be configured to sense one or more local conditions in the building and issue one or more requests for conditioned air. The HVAC system may be controlled by an HVAC control system and may include, among other elements, a communications block and a controller operatively coupled to the communications block. The communications block may receive one or more requests for conditioned air issued by one or more of the plurality of register vents and thus, the controller may receive the one or more requests for conditioned air. In some instances, one or more of the HVAC components such as hydronic heating and/or electric heating strips may be utilized in a stage with one or more other HVAC components such as forced air heating systems. The electric heating strips may be a stage in a heat pump system, where the electric heating strips may supplement the heat pump system when outdoor temperatures become too cold for the system to work entirely based on the heat pump output.

The present invention also relates to a method for sustainably generating energy and providing to an air conditioning to a building interior, the method comprising the steps of:
providing a system according to the invention,
collecting electrical energy from the photovoltaic component;
employing at least part of the electrical energy to circulate a heat transfer fluid through the one or more heat exchange modules in interior layer, and absorbing heat from, or radiating heat into the air flowing by natural circulation through the venting gap between the underside of the exterior photovoltaic layer and a top surface of the interior layer comprising the heat exchange modules, and using the heat differential in the heat transfer fluid to drive a heat pump providing energy to a secondary fluid system, or removing energy from the secondary fluid system.

Advantageously, the method according to the invention, preferably comprises the step of heating or cooling the interior of a building through the secondary fluid system; and/or the step of heating of cooling the exterior layer, for example to remove condensation or ice/snow from the heat exchange modules, or the photovoltaic panels.

The present invention also relates to a load-bearing structure for mounting a building integrated thermal and photovoltaic cladding system according to the invention, comprising
at least first and second shaped profile sheet or extrudate metal beams acting as laterally extending mounting member, and arranged side by side and in parallel with each other to define a plane, each profiled sheet metal beam having a closed configuration of side walls along its longitudinal axis defining a hollow cross-section perpendicular to its longitudinal axis; preferably, wherein each laterally extending member comprises a body forming a hollow essentially triangular or rectangular frame and an extended section aligned with one side of the frame and shaped to comprise two laterally extending side channels in the rectangular frame;
a mounting member forming a transverse support comprising one or more mounting and retaining members located in its upper edge;
one or more first sheet metal brackets, each first sheet metal bracket having an outer cross-sectional shape substantially conforming to an inner cross-sectional shape of a corresponding retaining member in the transverse support, having an inner cross-sectional shape substantially conforming to the outer-cross sectional shape of a corresponding metal beam, positioned in the corresponding retaining member in the transverse support, and attached to and supporting the corresponding hollow metal beam at least partially within the corresponding retaining member in the transverse support to capture the hollow metal beam within the first sheet metal bracket;
one or more second mounting brackets configured to couple to a photovoltaic panel or photovoltaic panel assembly to position and attach the photovoltaic panel or photovoltaic panel assembly to the photovoltaic panel rack in a desired location in the plane defined by the metal beams;
a portion of the laterally extending mounting members arranged to support one or more heat exchange modules in a spaced apart relationship below the exterior layer, defining a second plane defined by, and between or below the metal beams.

### DETAILED DESCRIPTION OF THE DRAWINGS

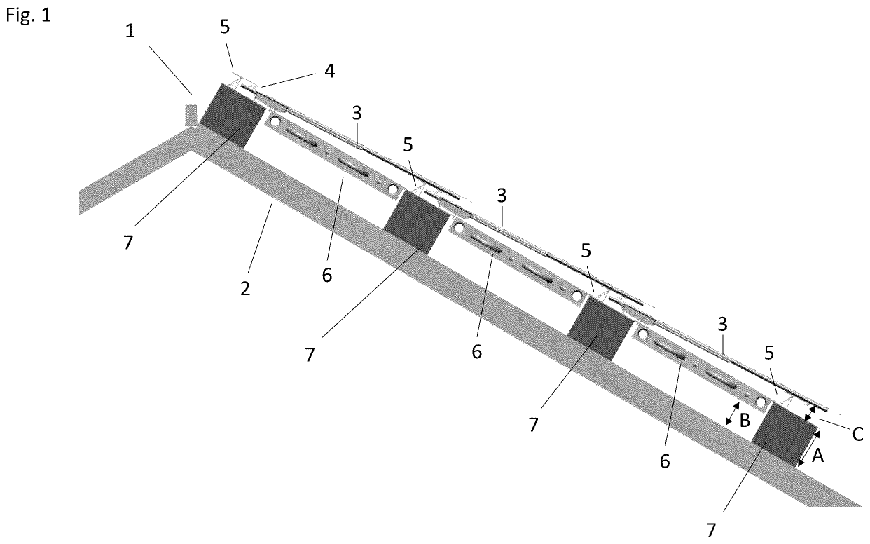

Turning now to the drawings, FIG. 1 is a perspective view from above of a preferred exemplary thermal and photovoltaic cladding system or assembly (1) mounted on a titled roof. Herein, a roof is shown comprising all elements: Photovoltaic panels (3), Mounting members (7), holding brackets (4) and mounting members (5), building structure (2). The system includes a plurality of mounting members (7) mounted on the roof and spaced a distance apart from each other in the y-direction. As can be seen in the figures, the mounting members (7) have a rectangular shape, but it is, nevertheless, contemplated that such mounting members can be provided in the form of any other suitable shape. A plurality of air-fluid heat exchange modules (6) are arranged in the space in the y-direction between two adjacent mounting members. In this non-limiting example, the top surface of each air-fluid heat exchange module is arranged such that it is essentially aligned with the corresponding top surfaces of the mounting members on which is it arranged. In this sense, the distance from the top surface of the air-fluid heat exchange modules and the roof is about, if not, the same as the height (A) of the mounting members.

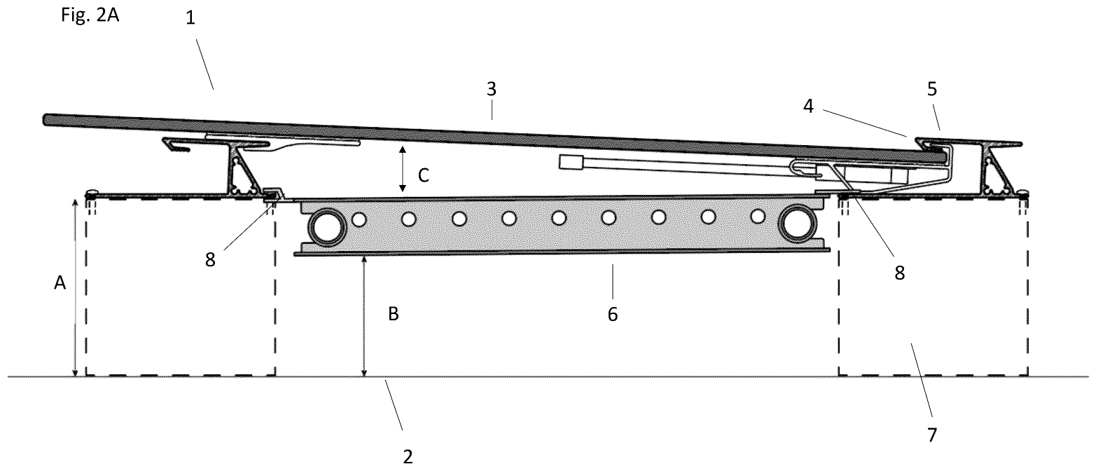

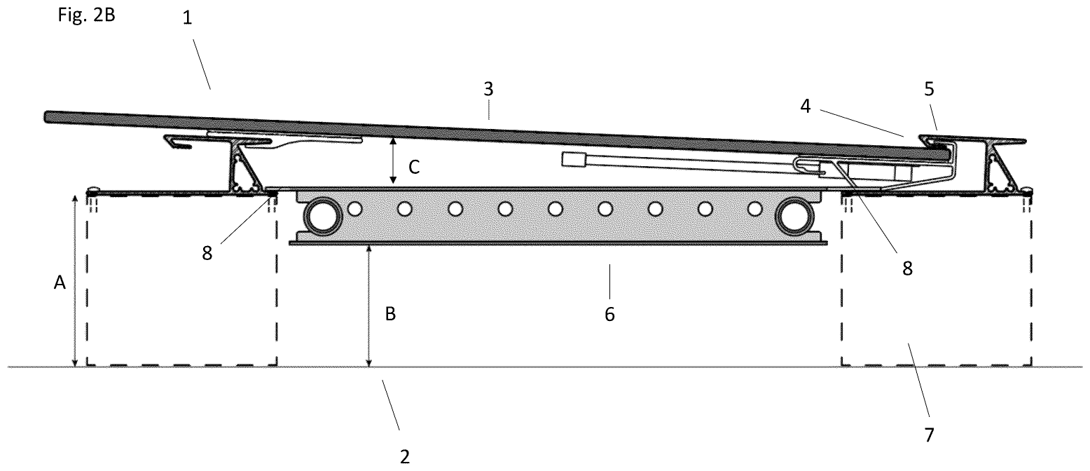

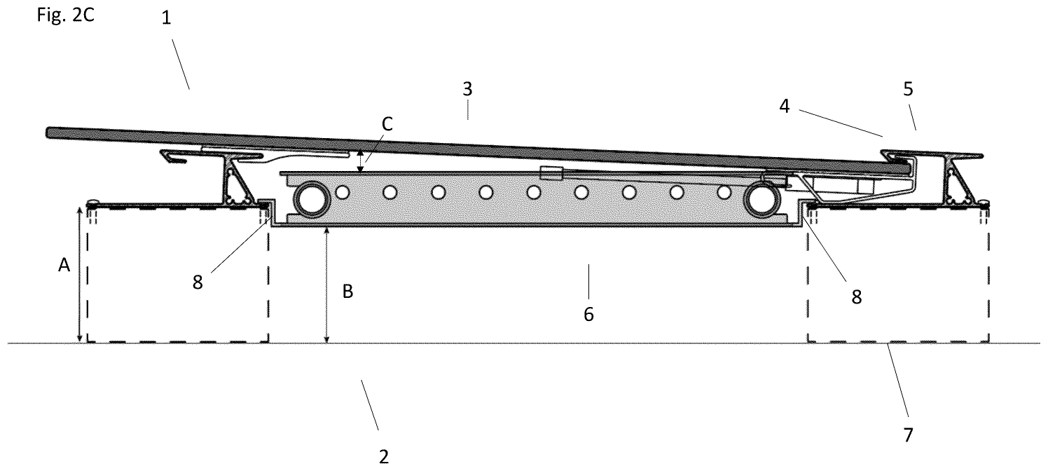

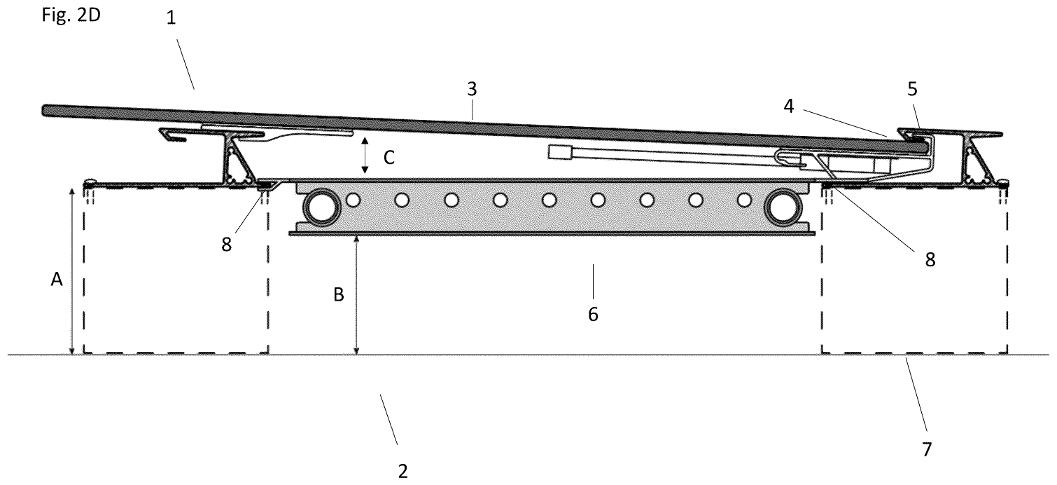

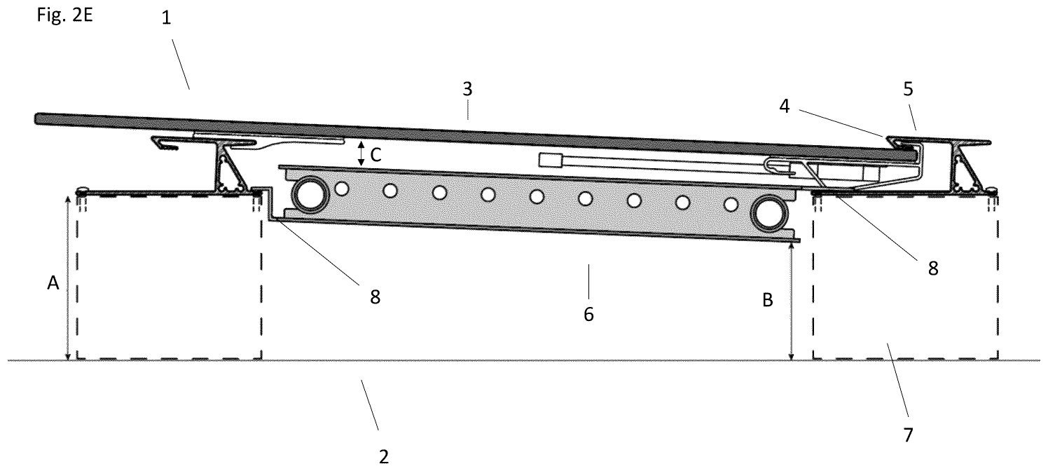

FIG. 2A to E are side views of preferred embodiments of the system according to the invention. Herein, the load bearing structure comprises a plurality of laterally extending photovoltaic panel mounting members (5); a plurality of base members (7) for supporting the laterally extending mounting members, each base member configured to rest on the underlying building construction (2) and extending upwardly towards a mounting bracket (4) configured for connecting the laterally extending members, thereby defining a first distance (A) from the underlying building construction to the laterally extending photovoltaic panel mounting member (5); and at least a first and second mounting bracket (4) positioned on the laterally extending photovoltaic panel mounting members for mounting and supporting each photovoltaic panel, the mounting brackets being connected to the laterally extending mounting members and extending outwardly from the laterally extending mounting members; wherein photovoltaic panels (3), when mounted in the assembly, are connected to a first mounting member (5) by at least a first mounting bracket (3) such that each panel is positioned at a sloping angle in relation to the building structure, and overlapping the upper end of a lower panel, thereby forming a scale-like exterior layer; and wherein the one or more air-fluid heat exchange modules (6) are mounted by a retaining element (8) to the mounting members (7) and in a position underneath the exterior layer defined by a second distance to the building structure (B), thereby forming the interior layer being spaced apart from the underside of the exterior layer by a third distance (C) defined by the height of the laterally extending mounting member and the module mounting member.

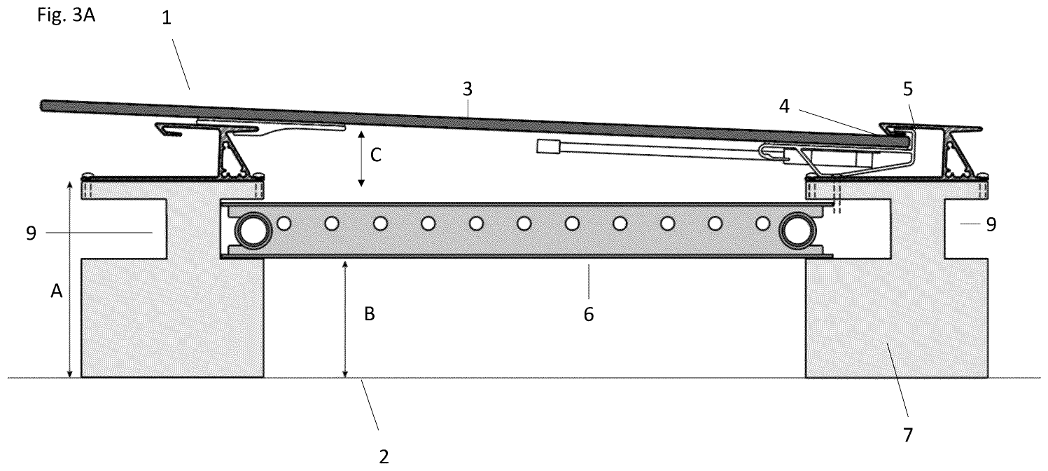

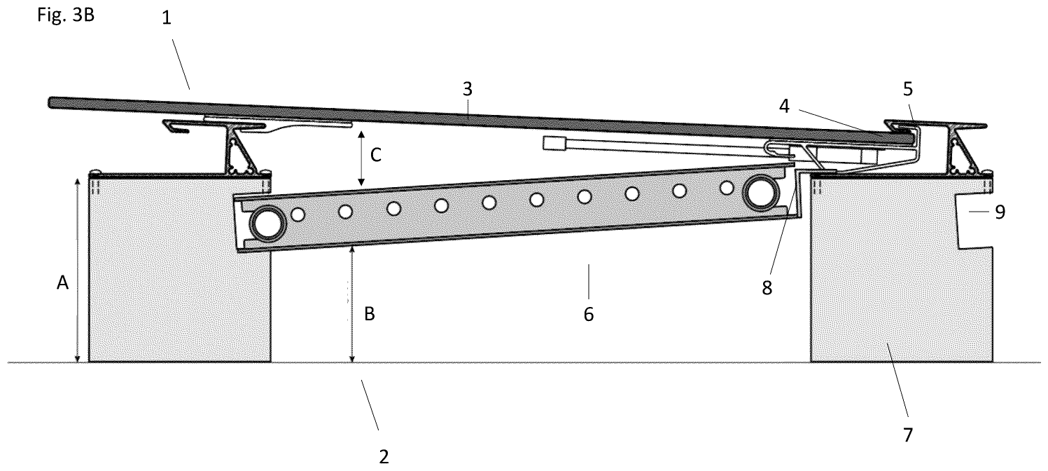

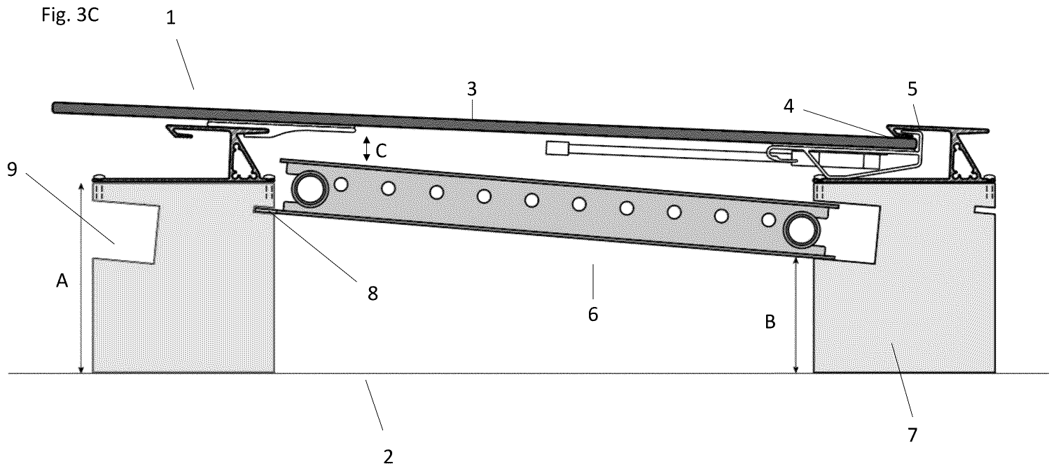

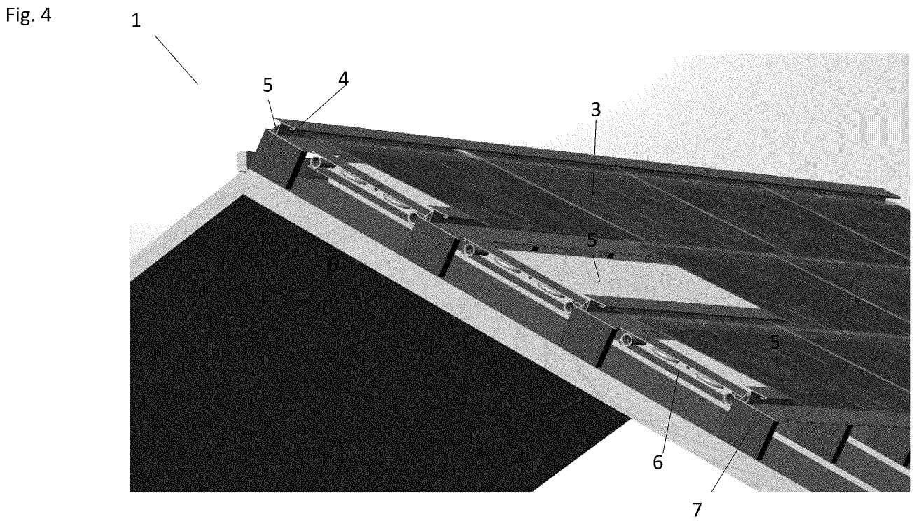

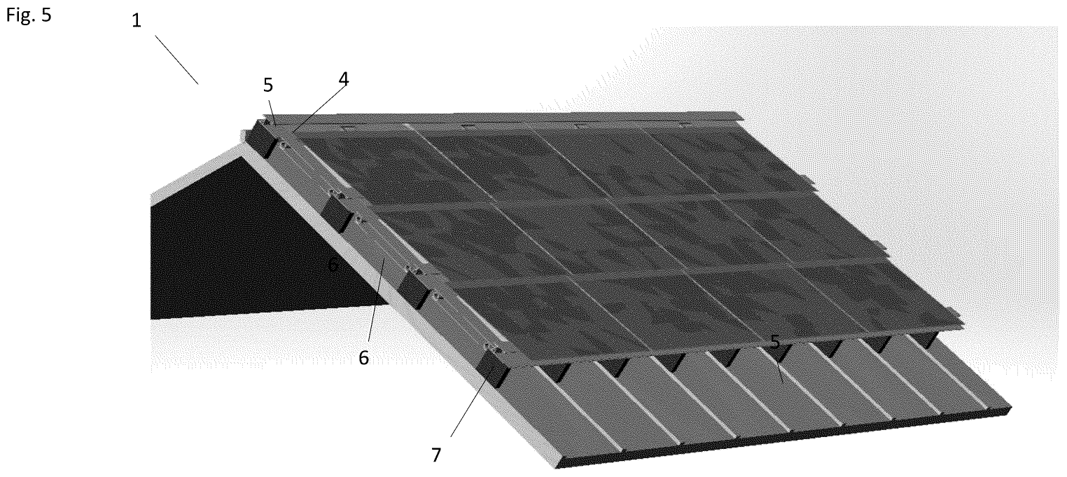

FIG. 2A discloses a preferred embodiment of the present system, wherein two different retaining elements (8) are used to secure and retain a fluid heat exchange module (6) underneath the member (5) and between the mounting members (7).
FIG. 2B discloses a preferred embodiment of the present system, wherein two retaining elements are extending flanges (8) on the upper surface fluid of the heat exchange module (6) underneath the member (5) and between the mounting members (7).
FIG. 2C discloses a preferred embodiment of the present system, wherein two retaining elements are extending flanges (8) on the lower surface of the fluid heat exchange module (6) underneath the member (5) and between the mounting members (7).
FIG. 2D discloses a preferred embodiment of the present system, wherein two different retaining elements (8) are used to secure and retain a fluid heat exchange module (6) underneath the member (5) and between the mounting members (7).
FIG. 2E discloses a preferred embodiment of the present system, wherein two different retaining elements (8) are used to secure and retain a fluid heat exchange module (6) underneath the member (5) and between the mounting members (7), one at the lower surface, and one at the upper surface, thereby tilting the exchange module into the air flow.
FIG. 3A to Care side views are side views of preferred embodiments of the system according to the invention. Herein, the mounting members are adapted and configured with recesses on the members to receive at least one side of the heat exchange module.
FIG. 3A discloses a preferred embodiment of the present system, wherein two different retaining recesses are present as side channels in the mounting members (7) and wherein the heat exchange module is slotted into those to secure and retain the module (6) underneath the member (5) and between the mounting members (7).
FIG. 3B discloses a preferred embodiment of the present system, wherein a single, angled retaining recess is are present as a side channel in the mounting members (7) and wherein the heat exchange module is slotted into the channel se to secure and retain the module (6), whereas a retaining profile extends from the underside of the module (6) thereby tilting the exchange module into the air flow and towards the photovoltaic panel.
FIG. 3C discloses a preferred embodiment of the present system, wherein a single, angled retaining recess is are present as a side channel in the mounting members (7) and wherein the heat exchange module is slotted into the channel se to secure and retain the module (6), whereas a retaining profile extends from the underside of the module (6) thereby tilting the exchange module into the air flow, and essentially in parallel with the photovoltaic panel.
FIGS. 4 and 5 are perspective views showing the assembly or system from an about 45° angle, and showing the elements (FIG. 4), or the view of the outside viewer (FIG. 5), wherein only the photovoltaic panels are visible.
A roof, or tilted more generally, building envelop, according to the invention and the elements used for preparing it can be regarded as a part of an overall system for use of photovoltaic energy, as well as heat exchange between the air underneath the photovoltaic panels. This has the benefit that no force-ventilated heat exchange modules are required, while at the same time making good use of the building surface available, and without the noise generated by the forced ventilation. Also, the present system has the benefit of allowing to remove snow and ice from both panels and heat exchange modules by inverting the heat transfer.

### List of References

A First Distance
B Second Distance
C Third Distance
1 System on a Building
2 Building Structure
3 Photovoltaic Panel (forming the exterior layer)
4 Mounting Bracket for Panel (3)
5 Laterally Extending Mounting Element
6 Heat Exchange Module (forming the interior layer)
7 Mounting Element
8 Retaining element
9 Recess

1. A building-integrated thermal and photovoltaic cladding system comprising:
an exterior layer comprising one or more photovoltaic panels,
an interior layer comprising one or more air-fluid heat exchange modules;
a load-bearing structure configured to maintain the exterior layer in spaced apart relation to the interior layer, and providing an air flow conduit therebetween for receiving air from the exterior and allowing the air flow to generally pass over the interior layer by natural circulation, wherein the system comprises:
(i) a plurality of laterally extending photovoltaic panels;
(ii) a plurality of mounting members, each member configured to rest on the underlying building construction and extending upwardly towards a laterally extending mounting rail configured for connecting to the mounting members, thereby defining a first distance (A) from the underlying building construction to the laterally extending mounting rail; and
(iii) a plurality of laterally extending mounting rails configured for connecting to the mounting members, and configured for mounting and supporting each photovoltaic panel; and
(iv) one or more a first mounting bracket positioned on a laterally extending mounting rail for mounting and supporting each photovoltaic panel, the one or more mounting brackets being connected to the laterally extending mounting rails and extending outwardly from the laterally extending mounting members;
wherein photovoltaic panels, when mounted in the assembly, are connected to a first mounting member by a first mounting bracket such that each panel is positioned at a sloping angle in relation to the building structure, and overlapping the upper end of a lower panel, thereby forming a scale-like exterior layer; and
wherein the one or more air-fluid heat exchange modules are mounted, preferably independently from the photovoltaic scale-like exterior layer, by a retaining element to the laterally extending mounting rail and/or the mounting members in a position underneath the exterior layer at a position defined by a second distance to the building structure (B), forming the interior layer being spaced apart from the underside of the exterior layer by a third distance (C) defined by the height of the laterally extending mounting member and the underside of the photovoltaic module.

2. The system according to claim 1, further comprising:
at least an air vent at each photovoltaic panels in the exterior layer, the air vent generally disposed at or near the lower end of each photovoltaic element; and
a venting opening generally disposed at the lower end of the exterior layer, the venting opening configured to disperse and/or utilize the air flow, each air vent in in fluid flow communication with the air flow channel and the venting opening.

3. The system according to claim 1, configured for installation on a building structure, comprising:
at least one photovoltaic panel (3) having opposing top and bottom edges,
at least one air-fluid heat exchange module (6);
a load-bearing structure comprising:
a plurality of mounting members (7), each mounting member having a distance of height (A) in a z-direction on the z-axis and spaced a distance apart from each adjacent mounting member (7) in a y-direction on the y-axis, wherein the at least one air-fluid heat exchange module (6) is arranged on the y-axis at a position between two adjacent mounting members (7) and spaced a second distance (B) apart from the building structure (2) in the z-direction, and
a corresponding plurality of mounting brackets (5), each mounting bracket (5) arranged on a top surface of a respective one of the plurality of mounting members (7), wherein the at least one photovoltaic panel (3) is mounted between two adjacent mounting brackets and spaced a third distance (C) above the at least one air-fluid heat exchange module (6) in the z-direction, and
an air flow conduit arranged between the at least one photovoltaic panel (3) and the at least one air-fluid exchange module (6), the air flow conduit configured to receive an air flow and to allow the air flow to pass over the at least one air-fluid heat exchange module (6) by natural circulation.

4. The system according to claim 3, further comprising respective first and second mounting rails, wherein the first mounting rail is configured to fittingly secure the top edge of the at least one photovoltaic panel in a recess of the corresponding mounting bracket on a first of the two adjacent mounting members, and the second mounting rail is configured to fittingly engage with the corresponding mounting bracket on a second of the two adjacent mounting members to secure the at least one photovoltaic panel proximal to the bottom edge.

5. The system according to claim 1, further comprising respective first and second retaining elements, the first retaining element configured to mount a top edge of the at least one air-fluid exchange module to the corresponding mounting member and/or the corresponding mounting bracket on a first of the two adjacent mounting members, and the second retaining element configured to mount a bottom edge of the at least one air-fluid exchange module to the corresponding mounting member and/or the corresponding mounting bracket on a second of the two adjacent mounting members.

6. The system according to claim 1, wherein the at least one photovoltaic panel comprises an air vent arranged at or proximal to the bottom edge, and a vent opening in fluid communication with the air vent and the air flow; and an air vent arranged at or proximal to the top edge where the panel is positioned underneath a preceding higher arranged panel in an upward direction.

7. The system according to claim 1, further comprising a fluid piping system configured to transfer a heat exchange fluid through the at least one air-fluid heat exchange module.

8. The system according to claim 7, wherein the fluid piping system comprises connection pipes comprising connectors adapted for removably connecting the at least one heat exchange module to the piping system, preferably at predefined positions aligned with the plurality of mounting members.

9. The system according to claim 7, wherein the fluid piping system comprises at least a coaxial heating-and-cooling tube connected directly to and in fluid communication with the at least one air-fluid heat exchange module.

10. The system according to claim 1, wherein the at least one heat exchange module is fluidly connected to a heating and/or cooling system comprising a heat pump through fluid piping and/or an electrically driven pumping or fluid circulation device.

11. The system according to claim 9, wherein the heat pump is connected to a secondary fluid system in fluid connection with a building HVAC system.

12. The system according to claim 1, wherein the at least one photovoltaic panel comprises a frameless photovoltaic panel assembly for incorporation into a roof or façade cladding, the frameless photovoltaic panel assembly comprising:
at least one photovoltaic panel comprising a transparent top sheet, a backsheet, and one or more photovoltaic cells positioned between the top sheet and backsheet;
side elongate elements extending vertically along lateral side edges of the at least one photovoltaic panel;
an upper elongate sealing element extending along the top edge of the photovoltaic panel and attached to an upper end of each side elongate element,
a lower elongate sealing element extending along the bottom edge of the photovoltaic panel and attached to an underside of the photovoltaic panel, the lower elongate sealing element configured to allow for air venting from the system to pass through, thereby forming an air vent.

13. The system according to claim 12 for mounting on a pitched roof, comprising a plurality of photovoltaic panels, wherein the photovoltaic panels are arranged in a overlapping scale-like exterior layer on a downward facing surface of the roof to form a photovoltaic electric grid,

14. The system according to claim 1, wherein the load-bearing structure further comprises apertures for allowing passage of electrical grid wiring and fluid piping.

15. The system according to claim 1, wherein each mounting bracket forms a metal profile fastened to a respective mounting member.

16-31. (canceled)

32. A method for sustainably generating energy and providing air conditioning to a building interior, the method comprising the steps of:
providing the system according to claim 1,
collecting electrical energy from the at least one photovoltaic panel;
employing at least part of the electrical energy to circulate a heat transfer fluid through the at least one air-fluid heat exchange module, by:
absorbing heat from, or radiating heat into, air flowing by natural circulation through a venting gap between an underside of the at least one photovoltaic panel and a top surface of the at least one air-fluid heat exchange moule, and
using a heat differential in the heat transfer fluid to drive a heat pump, the heat pump either providing energy to a secondary fluid system, or removing energy from the secondary fluid system.

33. The method according to claim 32, further comprising heating or cooling the building interior through the secondary fluid system.

34. A method for sustainably generating energy and providing to an air conditioning to a building interior, the method comprising the steps of:
providing the system according to claim 1,
collecting electrical energy from the photovoltaic component;
employing at least part of the electrical energy to circulate a heat transfer fluid through the one or more heat exchange modules in interior layer, and absorbing heat from, or radiating heat into the air flowing by natural circulation through the venting gap between the underside of the exterior photovoltaic layer and a top surface of the interior layer comprising the heat exchange modules, preferably at each photovoltaic element and using the heat differential in the heat transfer fluid to drive a heat pump providing energy to a secondary fluid system, or removing energy from the secondary fluid system.

35. The method according to claim 34, further comprising the step of heating or cooling the interior of a building through the secondary fluid system.

36. A load-bearing structure for mounting the building integrated thermal and photovoltaic cladding system according to claim 1, comprising
at least first and second shaped profile sheet or extrudate metal beams acting as laterally extending mounting member, and arranged side by side and in parallel with each other to define a plane, each profiled sheet metal beam having a closed configuration of side walls along its longitudinal axis defining a hollow cross-section perpendicular to its longitudinal axis; preferably, wherein each laterally extending member comprises a body forming a hollow essentially triangular or rectangular frame and an extended section aligned with one side of the frame and shaped to comprise two laterally extending side channels in the rectangular frame;
a mounting member forming a transverse support comprising one or more mounting and retaining members located in its upper edge;
one or more first sheet metal brackets, each first sheet metal bracket having an outer cross-sectional shape substantially conforming to an inner cross-sectional shape of a corresponding retaining member in the transverse support, having an inner cross-sectional shape substantially conforming to the outer-cross sectional shape of a corresponding metal beam, positioned in the corresponding retaining member in the transverse support, and attached to and supporting the corresponding hollow metal beam at least partially within the corresponding retaining member in the transverse support to capture the hollow metal beam within the first sheet metal bracket;
one or more second mounting brackets configured to couple to a photovoltaic panel or photovoltaic panel assembly to position and attach the photovoltaic panel or photovoltaic panel assembly to the photovoltaic panel rack in a desired location in the plane defined by the metal beams;
a portion of the laterally extending mounting members arranged to support one or more heat exchange modules in a spaced apart relationship below the exterior layer, defining a second plane defined by, and between or below the metal beams.
